(19) United States
(12) Patent Application Publication
(10) Pub. No.: US 2026/0341878 A1
(43) Pub. Date: Oct. 29, 2026

(54) Stackable Power Modules Having Mechanical Lockout Interfaces

(71) Applicant: Milwaukee Electric Tool Corporation, Brookfield, WI (US)

(72) Inventor: Aaron M. Broeckert, Milwaukee, WI (US)

(21) Appl. No.: 19/571,194

(22) Filed: Mar. 18, 2026

Related U.S. Application Data
(60) Provisional application No. 63/796,876, filed on Apr. 29, 2025.

(51) Int. Cl. H01M 50/258; H01M 50/247

(52) U.S. Cl. CPC H01M 50/258; H01M 50/247; H01M 2220/30

(57) ABSTRACT

Embodiments of a stackable portable power module are provided. The module includes a top surface and a bottom surface. The top surface defines a first column having a first cleat pocket and a second column having a second cleat pocket. The bottom surface defines a third column having a first cleat and a fourth column having a second cleat. The first column and/or the second column includes a first feature configured to permit or prevent the first cleat or the second cleat of an upwardly adjacent module from seating in the first cleat pocket or the second cleat pocket, respectively. Further, the third column and/or the fourth column includes a second feature configured to permit or prevent the first cleat or the second cleat from seating in the first cleat pocket or the second cleat pocket, respectively, of a downwardly adjacent module.

### CROSS-REFERENCE TO RELATED PATENT APPLICATIONS

The present application claims the benefit of and priority to U.S. Provisional Application No. 63/796,876 filed on Apr. 29, 2025, each of which is incorporated herein by reference in its entirety.

### BACKGROUND OF THE INVENTION

The present disclosure is directed generally to power systems and related devices and, in particular to methods of mechanically connecting or locking out mechanical connection between modules of such systems and devices.

Bringing power to a jobsite is difficult, especially when a construction site has not had power routed to it yet. The conventional solution to this problem is bringing gas generators to the jobsite. However, there are problems associated with the use of gas generators, such as emissions in the form of fumes and noise, that make them suitable only for outdoor use. Further, once set up outside, long extension cords have to be routed to the task site from the generator, which creates a tripping hazard. These problems make gas generators a nuisance and potentially safety risk on a jobsite.

### SUMMARY OF THE INVENTION

Embodiments of the present disclose address the problems associated with the use of gas generators. In particular, embodiments of the present disclosure relate to a portable power ecosystem with discrete, modular components that allow users to build the precise portable power system for their unique needs. Embodiments of the presently disclosed ecosystem include multiple components, such battery cores, power management units (with an internal inverter and charger, AC, and DC outputs), battery chargers for various battery voltages, and floor and wall mounting plates. Embodiments of the presently disclosed portable power ecosystem provide battery capacity scalability, as well as DC-DC charging for greater efficiency when charging battery packs.

As will be discussed more fully below, the discrete, modular components are mechanically connected using a cleat and pocket interface (e.g., PACKOUT™ interface available from Milwaukee Electric Tool Corporation, Brookfield, WI) providing an interchangeable and interlocking storage system. In one or more embodiments, the discrete, module components are stackable and encompass such components as toolboxes, mobility solutions, and power tools. Advantageously, the disclosed platform is a robust, easily operable method for stacking, connecting, and disconnecting different products utilizing the same cleat and pocket interface from each other. By leveraging this existing, recognized, popular cleat and pocket interface for making mechanical connections in the portable power ecosystem, the newly disclosed electrical modules can be adopted and integrated into existing cleat and pocket interface products to expand the capabilities of the cleat and pocket interface platform.

Various embodiments of the invention relate to portable power systems and related devices. In various embodiments, such portable power systems and related devices include coupling mechanism(s) (e.g., male and/or female coupling components) configured to engage with units of a modular storage system, such as a modular or stackable tool storage system, a modular worksite storage system, a modular transit storage system, etc. In various embodiments, the disclosure relates to portable power systems and related devices that utilize, couple to, or otherwise support rechargeable batteries, such as rechargeable power tool batteries.

As will be discussed more fully below, descriptions of embodiments of the portable power ecosystem detail mechanical interfaces that permit or prevent connection between modules within the portable power ecosystem. That is, the mechanical interfaces provide a way to design for compatible or incompatible stacking configurations to enhance the safety and performance of the modules within the ecosystem. For example, in certain configurations, the mechanical interface on the top surface of a first module will only allow for stacking of certain compatible modules on top of the first module and prevent stacking of other modules above the first module. Further, in other configurations, the mechanical interface on the bottom surface of the first module will only allow for stacking of the first module on top of certain compatible modules and prevent stacking of the first module above other modules.

In a first aspect, embodiments of the present disclosure relate to a module of a portable power ecosystem configured to be incorporated into a stacked configuration. The module comprises a top surface, a bottom surface, and a plurality of sidewalls connecting the top surface and the bottom surface. The top surface extends from a first end of the module to a second end of the module, and the top surface defines a first column comprising at least one first cleat pocket and a second column comprising at least one second cleat pocket. The bottom surface extends from the first end to the second end, and the bottom surface defines a third column comprising at least one first cleat and a fourth column comprising at least one second cleat. At least one of the first column or the second column comprises a first feature configured to permit or prevent the at least one first cleat of the third column or the at least one second cleat of the fourth column of an upwardly adjacent module in the stacked configuration from seating in the at least one first cleat pocket or the at least one second cleat pocket, respectively. Further, at least one of the third column or the fourth column comprises a second feature configured to permit or prevent the at least one first cleat of the third column or the at least one second cleat of the fourth column of the module from seating in the at least one first cleat pocket or the at least one second cleat pocket, respectively, of a downwardly adjacent module in the stacked configuration.

In a second aspect, embodiments of the disclosure relate to the module of the first aspect in which the first feature is a channel extending through the at least one first cleat pocket of the first column or the at least one second cleat pocket of the second column.

In a third aspect, embodiments of the disclosure relate to the module of the second aspect in which the channel extends only through the at least one first cleat pocket and not the at least one second cleat pocket.

In a fourth aspect, embodiments of the disclosure relate to the module of the second aspect in which the second feature is a rail extending through the at least one first cleat of the third column or the at least one second cleat of the fourth column.

In a fifth aspect, embodiments of the disclosure relate to the module of the fourth aspect in which the rail extends only through the at least one first cleat and not through the at least one second cleat.

In a sixth aspect, embodiments of the disclosure relate to the module of the first aspect in which the at least one first cleat pocket is a single cleat pocket that extends at least 50% of a distance between the first end and the second end.

In a seventh aspect, embodiments of the disclosure relate to the module of the sixth aspect in which the single cleat pocket comprises tabs that extend along sides of the single cleat pocket for at least 50% of a length of the single cleat pocket.

In an eighth aspect, embodiments of the disclosure relate to the module of the sixth aspect in which the single cleat pocket comprises a plurality of tabs along each side of the single cleat pocket.

In a ninth aspect, embodiments of the disclosure relate to the module of the sixth aspect in which the at least one first cleat is a single cleat that extends 50% of the distance between the first end and the second end.

In a tenth aspect, embodiments of the disclosure relate to the module of the sixth aspect in which the at least one first cleat comprises at least two first cleats and in which a cross-sectional profile of each of the at least two first cleats taken perpendicular to the bottom surface comprises a central post and a cross member that extends across the central post such that the cross member extends past opposing sides of the post.

In an eleventh aspect, embodiments of the disclosure relate to a portable power ecosystem. The portable power ecosystem includes a plurality of modules configured to be arranged in an interlocking stacked configuration. Each module of the plurality of modules comprises (i) a top mating interface including at least one cleat pocket in which the top mating interface is configured to interact with an upper adjacent module and (ii) a bottom mating interface comprising at least one cleat in which the bottom mating interface is configured to interact with a bottom adjacent module. The plurality of modules comprises a first module in which the top mating interface or the bottom mating interface is incompatible with the bottom mating interface or the top mating interface, respectively, of a second module of the plurality of modules to prevent interlocked stacking of the second module above or below the first module.

In a twelfth aspect, embodiments of the disclosure relate to the portable power ecosystem of the eleventh aspect in which, when the plurality of modules are in the interlocking stacked configuration, the plurality of modules are mechanically and electrically connected.

In a thirteenth aspect, embodiments of the disclosure relate to the portable power ecosystem of the twelfth aspect in which the first module and the second module are prevented from being electrically connected when the second module is arranged with the bottom mating interface over the top mating interface of the first module.

In a fourteenth aspect, embodiments of the disclosure relate to the portable power ecosystem of the eleventh aspect in which the top mating interface of a third module of the plurality of modules comprises at least one channel extending through the at least one cleat pocket.

In a fifteenth aspect, embodiments of the disclosure relate to the portable power ecosystem of the fourteenth aspect in which the bottom mating interface of a fourth module of the plurality of modules comprises at least one rail extending through the at least one cleat. The at least one rail is configured to be seated within the at least one channel when the fourth module is stacked on the third module in the interlocking stacked configuration.

In a sixteenth aspect, embodiments of the disclosure relate to the portable power ecosystem of the eleventh aspect in which the at least one cleat pocket of the top mating interface of a third module of the plurality of modules comprises a single cleat pocket that extends at least 50% of a distance between a first end and a second end of the third module.

In a seventeenth aspect, embodiments of the disclosure relate to the portable power ecosystem of the sixteenth aspect in which the single cleat pocket comprises tabs that extend along sides of the single cleat pocket for at least 50% of a length of the single cleat pocket.

In an eighteenth aspect, embodiments of the disclosure relate to the portable power ecosystem of the sixteenth aspect in which the single cleat pocket comprises a plurality of tabs along each side of the single cleat pocket.

In a nineteenth aspect, embodiments of the disclosure relate to the portable power ecosystem of the sixteenth aspect in which the at least one cleat of the bottom mating interface of a fourth module of the plurality of modules comprises a single cleat that extends at least 50% of the distance between a first end and a second end of the fourth module.

In a twentieth aspect, embodiments of the disclosure relate to the portable power ecosystem of the sixteenth aspect in which the at least one cleat of the bottom mating surface of a fourth module of the plurality of modules comprises at least two cleats and in which a cross-sectional profile of each of the at least two cleats taken perpendicular to a bottom surface of the fourth module comprises a central post and a cross member that extends across the central post such that the cross member extends past opposing sides of the post. Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIGS. 1A-1O depict mechanical engagement of modules using a cleat and pocket interface, according to exemplary embodiments;

FIGS. 2A and 2B depict a bottom module (FIG. 2A) having cleat pockets formed with a channel to receive a rail of corresponding cleats of a top module (FIG. 2B), according to exemplary embodiments;

FIGS. 2C-2I depict cleats, cleat pockets, and compatible and incompatible interfaces between the cleats and cleat pockets, according to exemplary embodiments;

FIGS. 3A and 3B depict interface codes for the top module and bottom module, respectively, according to exemplary embodiments;

FIG. 4 provides a compatibility table for 16 unique mating interfaces based on interface codes for the top surface of the bottom module and the bottom surface of the top module, according to exemplary embodiments;

FIGS. 5A and 5B provide a compatibility table for 256 unique mating interfaces based on interface codes for the top surface of the bottom module and the bottom surface of the top module, according to exemplary embodiments;

FIGS. 6A and 6B provide permissible and impermissible stack configurations for a combination of battery cores, power management unit, and battery chargers, according to exemplary embodiments;

FIGS. 7A and 7B depict a long cleat pocket and a variable cleat pocket, respectively, according to exemplary embodiments;

FIGS. 8A and 8B depict a long cleat and a T-shaped cleat, respectively, according to exemplary embodiments;

FIGS. 9A and 9B provide a comparison between an unmodified cleat and a T-shaped cleat, respectively, according to exemplary embodiments; and

FIGS. 10A-10H depict interactions between unmodified cleats and pockets, long cleats and long cleat pockets, and variable cleat pockets and T-shaped cleats, according to exemplary embodiments.

### DETAILED DESCRIPTION

Referring generally to the figures, various embodiments of portable power systems having modified cleat-and-pocket interfaces and related devices are provided.

In specific embodiments, portable power systems and related devices include coupling mechanism(s) (e.g., male and/or female coupling component(s)) configured to engage with units of a modular storage system, such as a modular or stackable tool storage system, a modular worksite storage system, a modular transit storage system, etc.

In various embodiments, portable power systems and related devices utilize, couple to, or otherwise support rechargeable batteries, such as rechargeable power tool batteries.

In specific embodiments, the portable power system and devices disclosed herein include one or more female couplers and/or one or more male couplers located on a surface of the component and that are configured to engage one or more corresponding mating couplers of an adjacent modular unit (e.g., a modular tool storage container, a modular utility module, a modular support component, etc.) In various embodiments, the male and female couplers described herein and shown in the figures are compatible with the coupling mechanism(s) described in International Patent International Patent Publication No. WO 2017/191628, which is hereby incorporated by reference in its entirety. In various embodiments, the female couplers and male couplers described herein engage with each other to rigidly couple together various components including such coupling structures.

Additional details are shown and described in the accompanying figures.

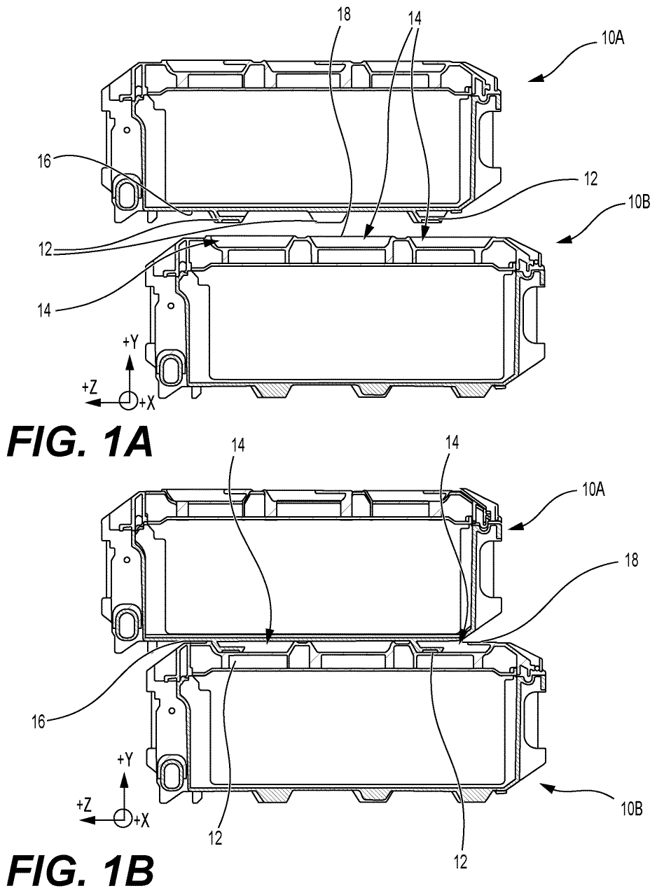

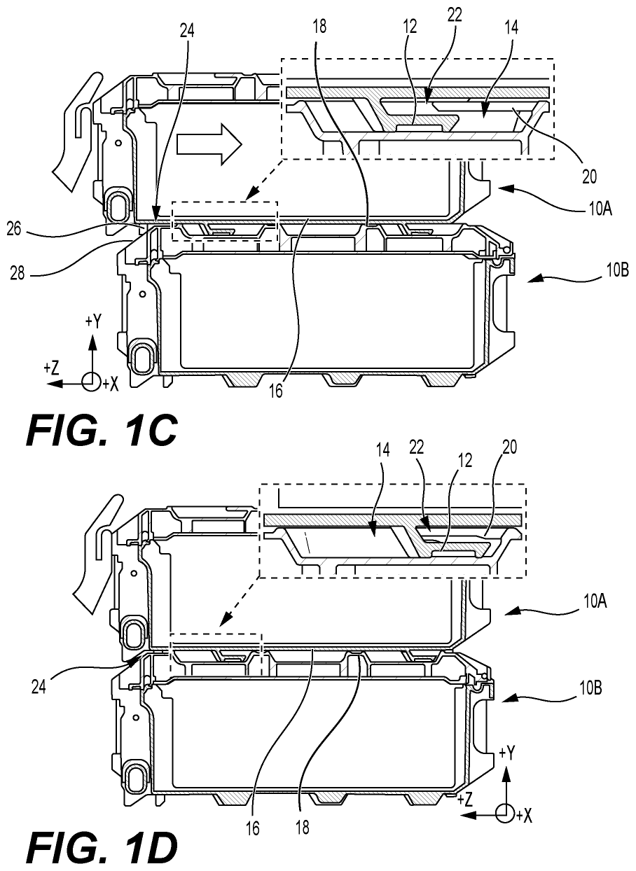

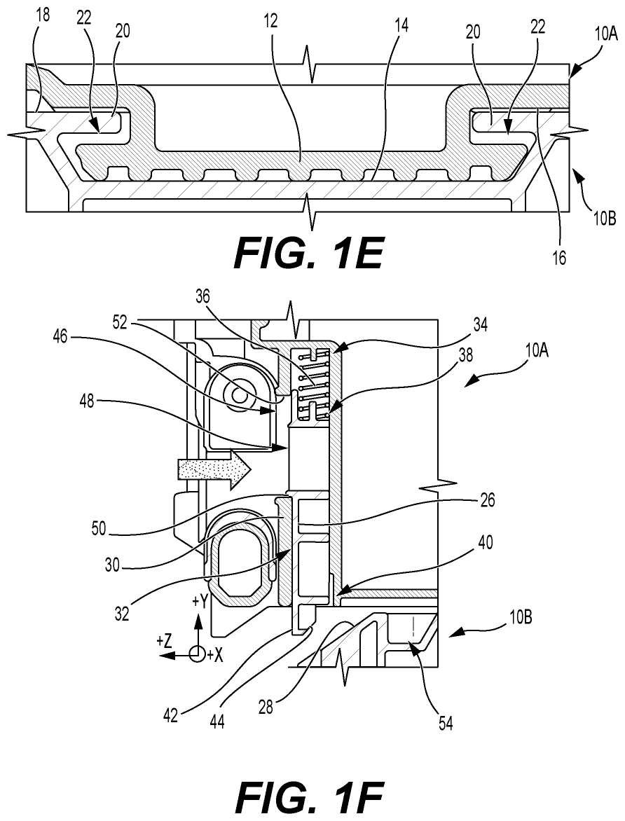

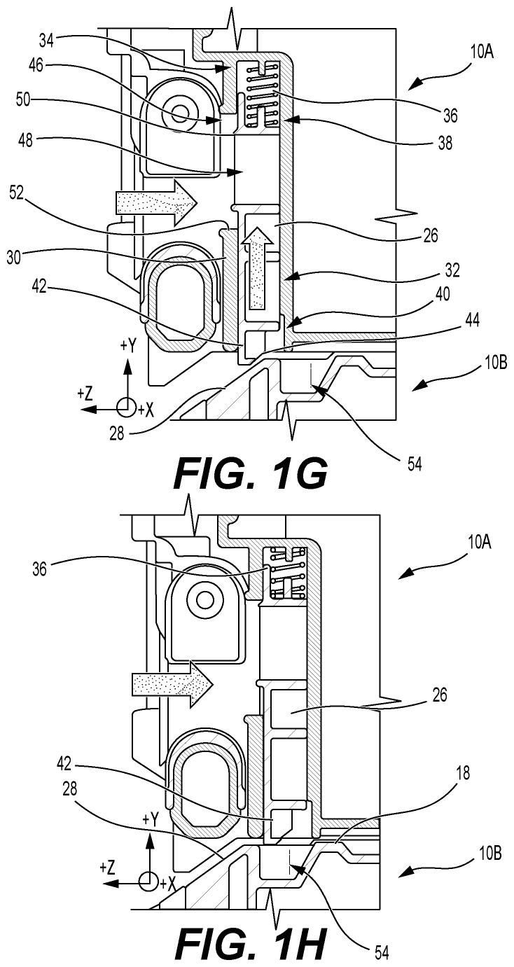

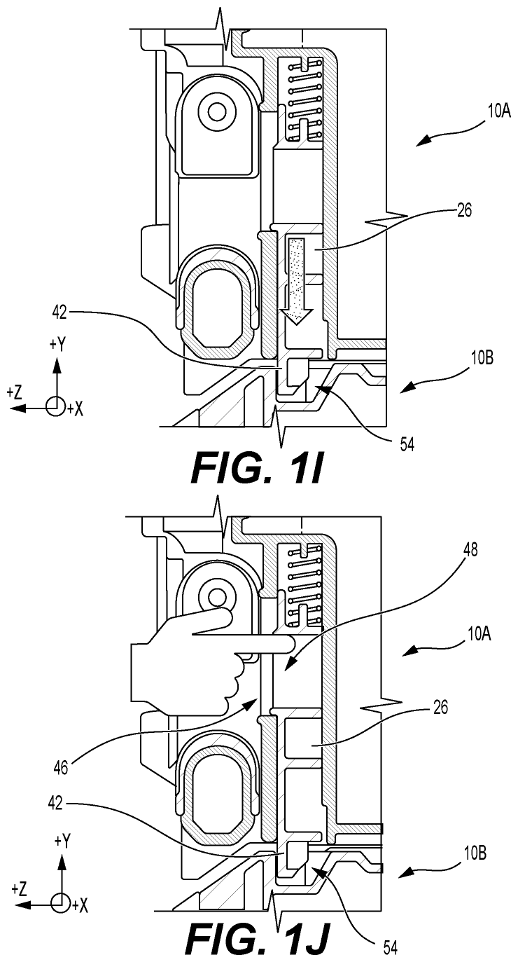

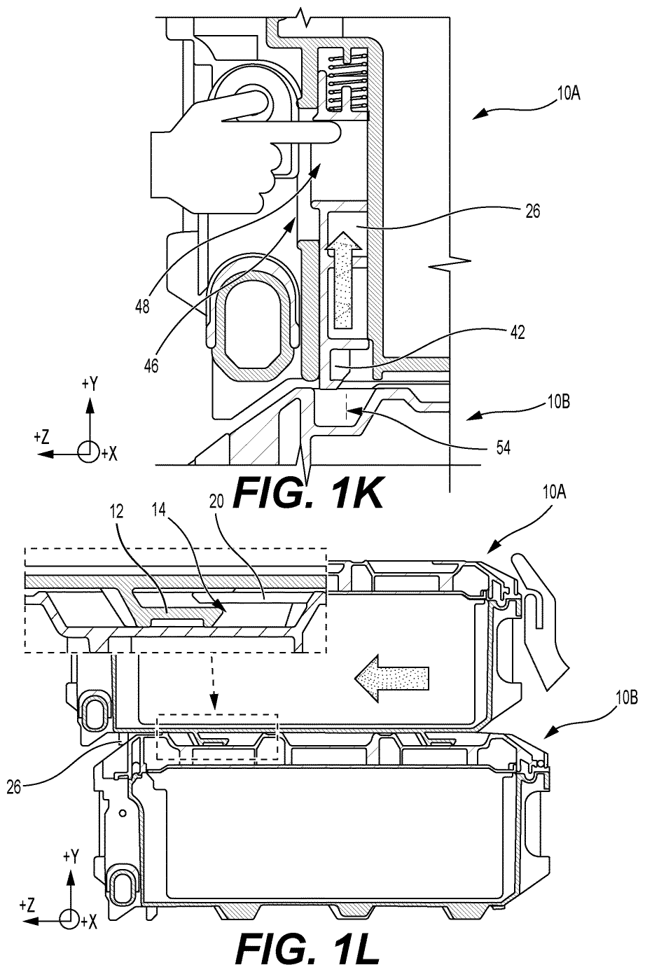

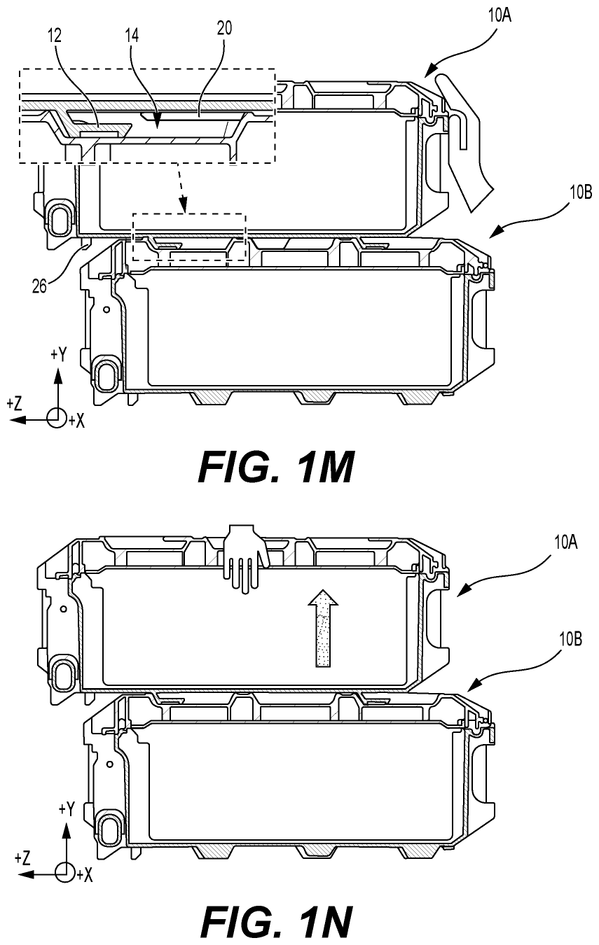

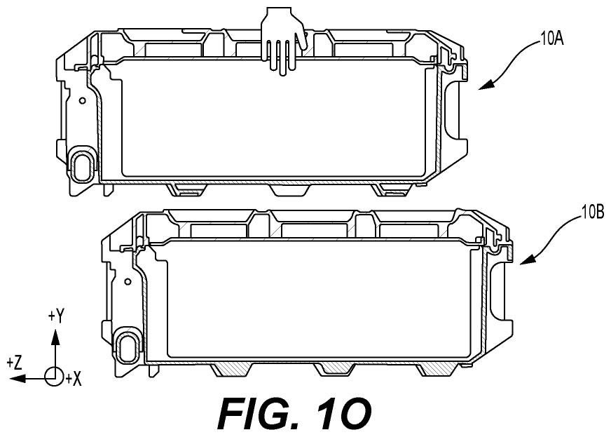

In order to introduce certain concepts related to the portable power ecosystem, the following description of the connection and disconnection between two cleat-and-pocket interface modules 10A and 10B is provided in relation to FIGS. 1A-1O is provided. This description is generally applicable to any cleat-and-pocket modules, such as PACKOUT™ modules available from Milwaukee Electric Tool Corporation (Brookfield, WI), including the modules of the portable power ecosystem described below. For the purposes of the following discussion, in both the connection and disconnection scenarios, the bottom module 10B is static and the top module 10A is dynamic.

As shown in FIGS. 1A-1E, connecting the two modules 10A, 10B together involves two steps: module drop (FIGS. 1A-1B) and module slide (FIGS. 1C-1E). In the presently disclosed portable power ecosystem, the modulus can be, e.g., a battery core, an inverter, or charger, amongst other possibilities. In the module drop step of FIGS. 1A-1B, a user aligns an array of cleats 12 of the top module 10A with a corresponding array of cleat pockets 14 of the bottom module 10B in the X and Z axes. According to the present disclosure, a “cleat” is an individual, rigid geometry that extends from a bottom surface 16 of certain modules 10A, 10B configured to be mated with a cleat pocket 14 of another module 10A, 10B. According to the present disclosure, a “cleat pocket” is an individual, rigid geometry that is a cavitation extending into a top surface 18 of certain modules 10A, 10B configured to house a corresponding cleat 12 of another module 10A, 10B. In particular, during the drop step of FIGS. 1A-1B, the cleats 12 will seat in the front half of the respective cleat pocket 14. The user translates the top module 10B in the −Y direction until the cleats 12 contact the bottom of the cleat pockets 14. Once positioned in the cleat pockets 14, further Y translation, X rotation, and Z rotation are constrained.

In the module slide step of FIGS. 1C-1E, the user translates the top module 10A in the −Z direction to lock the cleats 12 into the cleat pockets 14. In particular, at least one tab 20 extends over a portion of each cleat pocket 14 and engages the cleat 12. In one or more embodiments, each cleat pocket 14 includes two tabs 20 extending over two corners of the cleat pocket 14. When the top module 10A is slid so that the cleat 12 translates in the −Z direction within the cleat pocket 14, the tabs 20 fill negative space 22 (as shown in FIG. 1E) of the cleat 12. While the discussion pertained to a single cleat 12 in a corresponding cleat pocket 14, the entire array of cleats 12 on the bottom surface 16 of the top module 10A will simultaneously engage the entire array of cleat pockets 14 on the top surface 18 of the bottom module 10B. The interaction between the array of cleats 12 and the array of cleat pockets 14 constrains X translation and Y rotation.

In one or more embodiments, as shown in FIGS. 1F-1K, each module 10A, 10B includes a locking mechanism 24 configured to engage an adjacent module 10A, 10B to prevent accidental reverse translation in the +Z direction. In particular, as the top module 10A translates in the −Z direction, a spring-loaded locking tab 26 of the top module 10A is depressed as the locking tab 26 slides over a chamfered edge 28 of the bottom module 10B. As shown, e.g., in FIG. 1F, a wall 30 of each module 10A, 10B includes a sliding channel 32 within which the locking tab 26 is configured to translate up and down in the Y direction. A first end 34 of the sliding channel defines a first seat for one end of a compression spring 36. The locking tab 26 includes a corresponding seat 38 for the opposite end of the compression spring 36. The compression spring 36 biases the locking tab 26 in the deployed position (i.e., biasing the locking tab in the −Y direction).

At a second end 40 of the sliding channel 32 is an opening in the bottom surface 16 such that the locking tab 26, in the deployed state, extends from the sliding channel 32 and beyond the bottom surface 16. Thus, as mentioned, during sliding, a depending end 42 of the locking tab 26 engages the chamfered edge 28 of the bottom module 10B. In one or more embodiments, the depending end 42 includes a chamfered surface 44 configured to slide against the chamfered edge 28 of the bottom module 10B.

The wall 30 of the module 10A, 10B includes a first aperture 46, and the locking tab 26 includes a second aperture 48 or depression. To manually move the locking tab 26 against the bias of the compression spring 36, a user can insert one or more fingers through the first aperture 46 and into the second aperture 48 or depression of the locking tab 26. The user can then move the locking tab 26 by pulling against an edge of the second aperture 48 or depression.

In one or more embodiments, the first aperture 46 defines a range of movement (Y direction translation) of the locking tab 26. In particular, the second aperture 48 or depression may define a smaller opening that the first aperture 46, and the second aperture 48 or depression may include a peripheral flange 50 that engages a perimeter edge 52 of the first aperture 46. That is, the locking tab 26 can be moved in the +Y direction against the bias of the compression spring 36 until the peripheral flange 50 engages the top of the perimeter edge 52 of the first aperture 46, and the locking tab 26 can be moved in the −Y direction as biased by the compression spring 36 until peripheral flange 50 engages the bottom of the perimeter edge 52 of the first aperture 46.

As the top module 10A continues to translate in the −Z direction, the locking tab 26 slides against the chamfered edge 28, which causes the locking tab 26 to progressively translate in the +Y direction until the locking tab 26 reaches the top surface 18 of the bottom module 10B as shown in FIGS. 1G and 1H. The modules 10A, 10B have formed on the top surface 18 a recess 54 for the depending end 42 of the locking tab 26. Upon alignment of the locking tab 26 with the recess 54, the bias of the compression spring 36 causes the locking tab 26 to translate in the −Y direction until the depending end 42 is seated within the recess 54 as shown in FIG. 1I. Seating the locking tab 26 in the recess 54 constrains Z translation such that all degrees of freedom are constrained, and the two modules 10A, 10B are connected.

Disconnecting the two modules 10A, 10B involves three steps: lifting of the locking tab 26, sliding of the top module 10A, and lifting the module 10A as shown in FIGS. 1J-1O. In the step of lifting the locking mechanism 26, the user inserts a finger or fingers through the first aperture 46 and into the second aperture 48 or depression to pull the locking tab 26 in the +Y direction, unseating the depending end 42 of the locking tab 26 from the recess 54 as shown in FIGS. 1J and 1K. This provides a first degree of freedom, namely +Z translation, and allows the top module 10A to slide.

While the locking tab 26 is lifted, sliding of the top module 10A is initiated. As can be seen in FIGS. 1L and 1M, the user slides the top module 10A in the +Z direction until the array of cleats 12 disengage the tabs 20 of the corresponding array of cleat pockets 14 and the cleats 12 are in the front part of the cleat pockets 14. Finally, as shown in FIGS. 1N and 1O, the user lifts the top module 10A up (+Y translation) to separate the top module 10A from the bottom module 10B. In this way, the two modules 10A, 10B are disconnected once the cleats 12 of the top module clear the cleat pockets 14 of the bottom module 10B.

Having described the mechanical interaction to lock the modules 10A, 10B to each other, various aspects of the mechanical interface for facilitating or locking out electrical connections between the modules 10A, 10B are now described. Each of the aspects includes some or all of the components described in relation to FIGS. 1A-1O for forming the mechanical interaction, and such components will be identified with the same reference numerals (unless otherwise noted). In general, each of the modules regardless of the aspect for forming the electrical connection is, for example, a battery core, an inverter, a power management unit, or charger, amongst other possibilities, having the electrical and electronic components necessary to fulfill those functions.

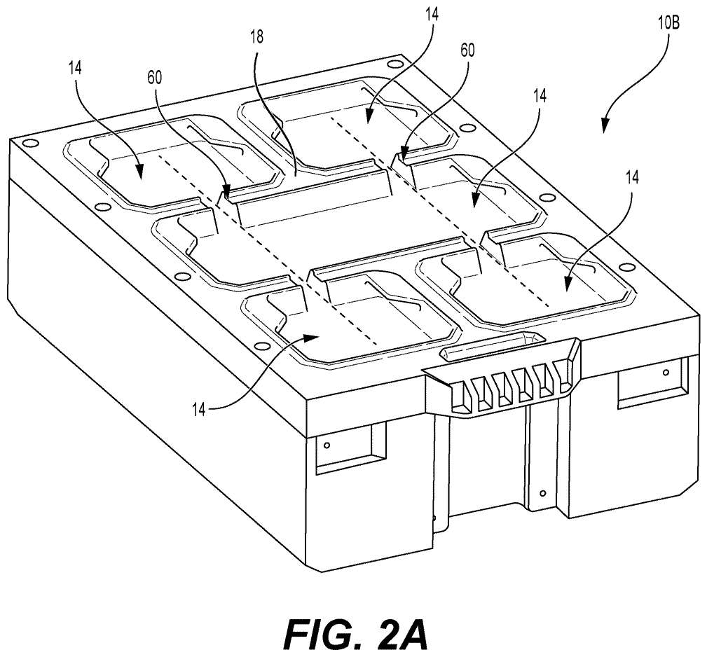

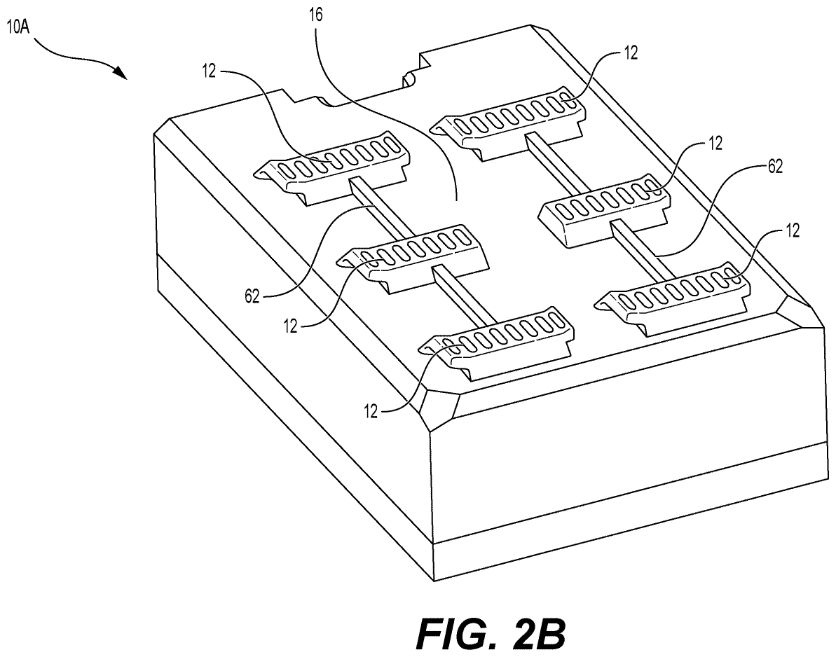

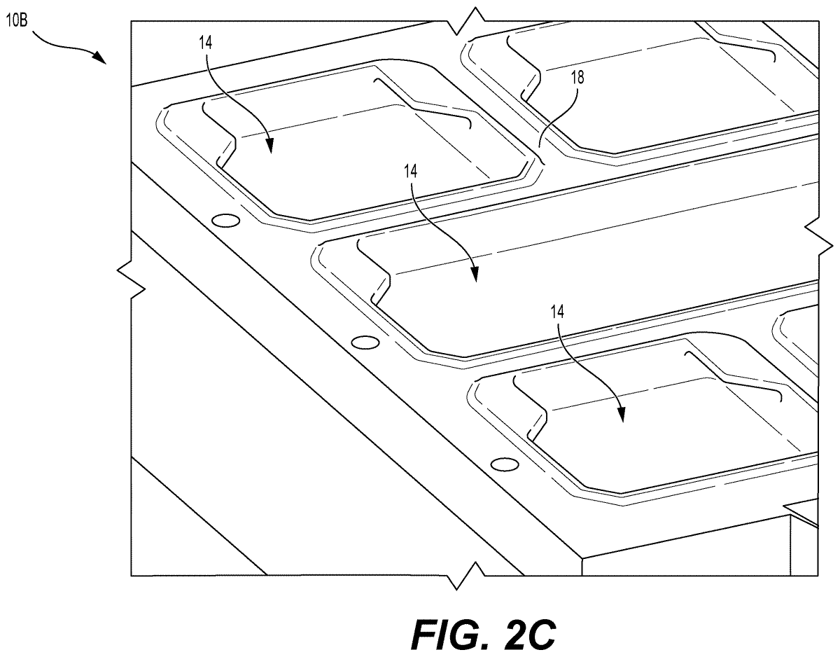

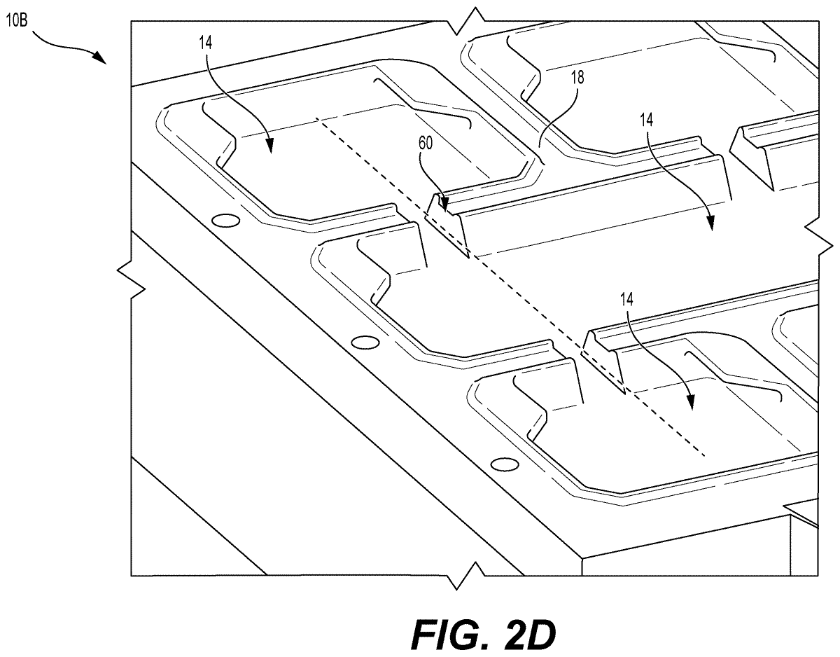

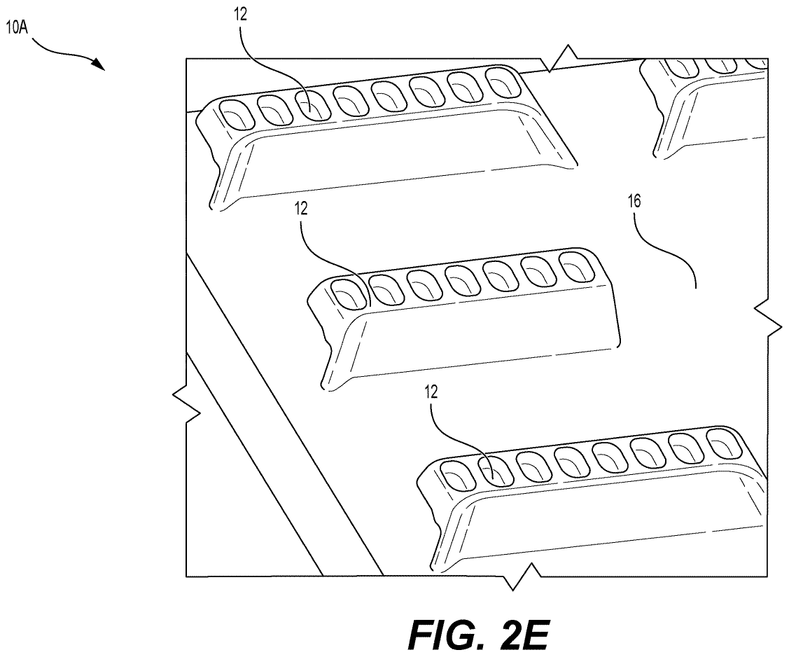

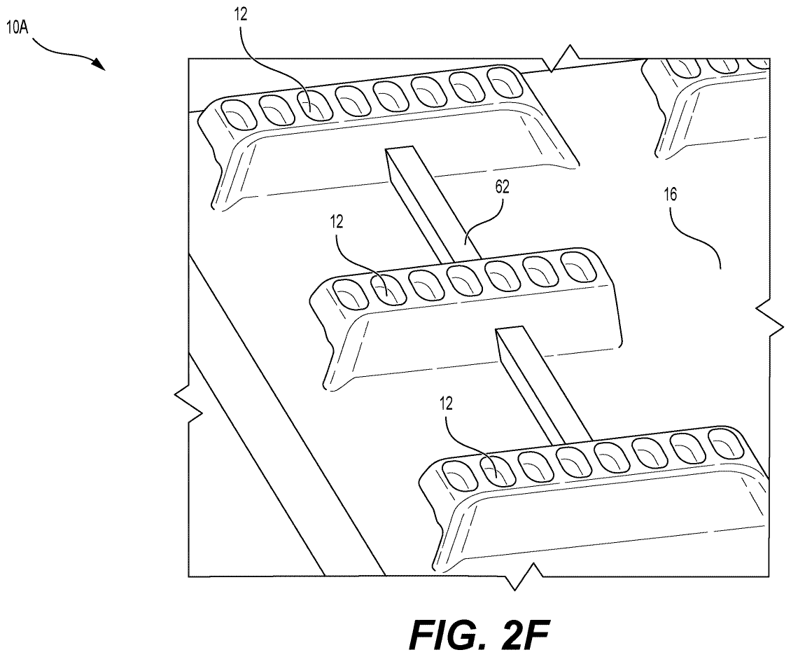

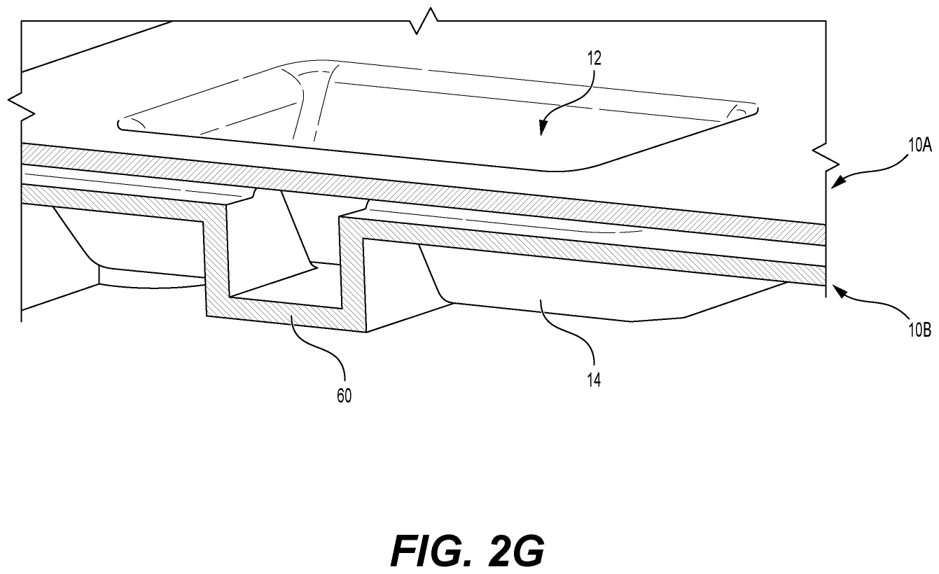

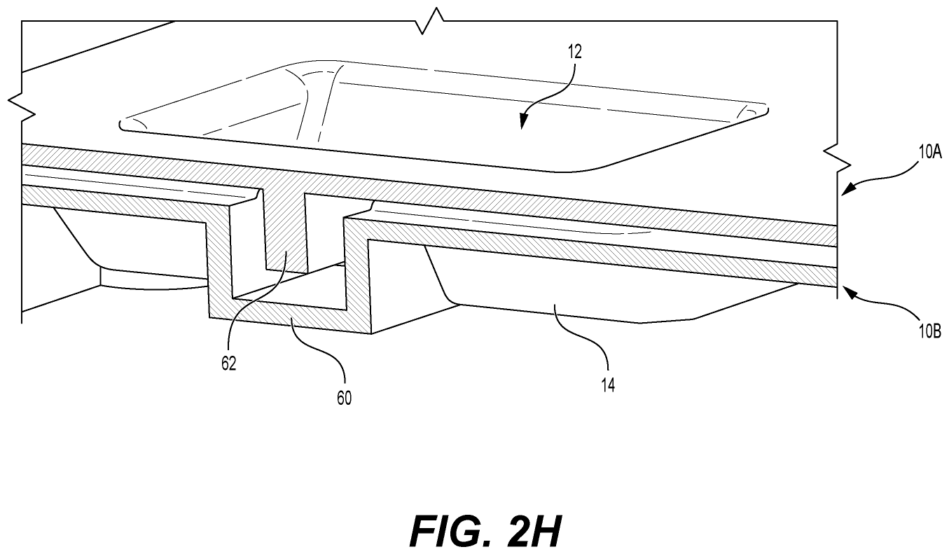

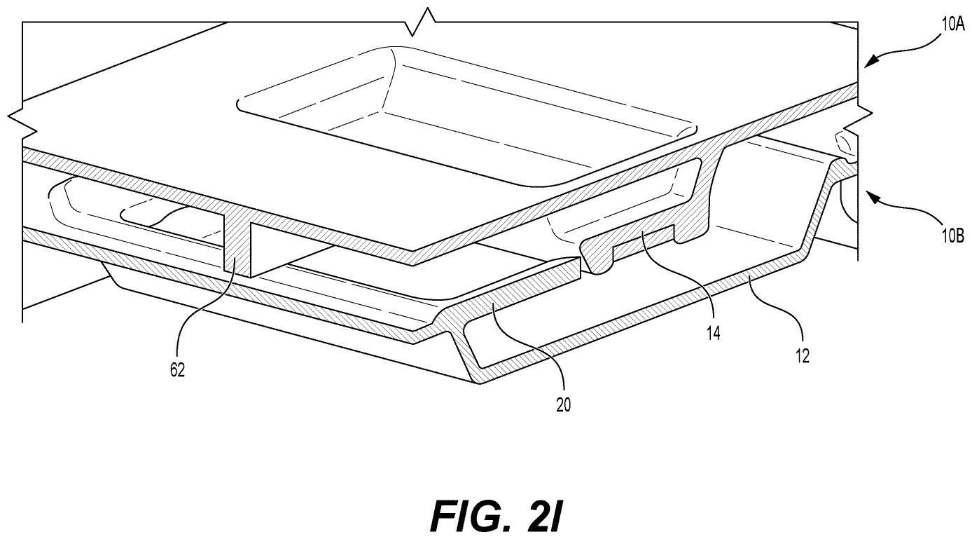

According to embodiments of the present disclosure, as shown in FIG. 2A, the bottom module 10B includes a feature, in particular a channel 60, on the top surface 18 that runs through the cleat pockets 14. In one or more embodiments, the channel 60 runs the entirety of the Z direction on the cleat-and-pocket interface. In the embodiment shown in FIG. 2A, two channels 60 are provided on a half-width form factor (relatively to a typical PACKOUT™ module system). In one or more other embodiments, the bottom module 10B may instead include one channel 60 or three or more channels 60, such as up to five channels 60. According to embodiments of the present disclosure, as shown in FIG. 2B, the top module 10A includes a corresponding features, such as a rail 62, on the bottom surface 16 that runs through the cleats 12. In one or more embodiments, the rail 62 runs the entirety of the Z direction on the cleat-and-pocket interface. In the embodiment shown in FIG. 2B, two rails 62 are provided on a half-width form factor. In one or more other embodiments, the top module 10A may instead include one rail 62 or three or more rails 62, such as up to five rails 62. As will be discussed more fully below, the number of channels 60 and rails 62 on each respective bottom module 10B and top module 10A may be used to create unique interfaces in which certain combinations of bottom modules 10B and top modules 10A are compatible whereas other combinations are not.

In various embodiments of the bottom module 10B and top module 10A, respective channels 60 or rails 62 may be “present” or “not present” extending through a cleat pocket 14 or a cleat 12. When a channel 60 or rail 62 is “not present,” the cleat-and-pocket interface is unmodified as shown in FIGS. 2C and 2E. When “present,” the respective bottom module 10B includes a channel 60 as shown in FIG. 2D, and the respective top module 10A includes a rail 62 as shown in FIG. 2F. For simplicity, in the following discussion, a channel 60 or rail 62 being “present” or “not present” will only be referred to as the digits 1 and 0, respectively. That is, a “0” on a top module 10A and bottom module 10B represents an unmodified cleat-and-pocket interface in which the channel 60 or rail 62 is not present, and a “1” on a top module 10A and a bottom module 10B represents a modified cleat-and-pocket interface in which a rail 62 and a channel 60 are present, respectively.

There are four possible interactions between the channels 60, rails 62, unmodified cleat 12 on the top module 10A, and unmodified cleat pocket 14 on the bottom module 10A. According to a first interaction, a channel 60 through the cleat pockets 14 of a the bottom module 10B interacts with an unmodified cleat 12 of the top module 10A. As shown in FIG. 2G, this interaction is a compatible cleat-and-pocket interface for the bottom module 10B and top module 10A. In particular, there is no structure obstructing the cleat 12 from interacting with the cleat pocket 14, resulting in the formation of a normal cleat-and-pocket interface.

According to a second interaction, a channel 60 through the cleat pockets 14 of the bottom module 10B interacts with a rail 62 through the cleats 12 of the top module 10A. As shown in FIG. 2H, this interaction is a compatible cleat-and-pocket interface for the bottom module 10B and the top module 10A. In particular, the rail 62 extending through the cleats 12 of the top module 10A is able to slide through the channel 60 of the cleat pockets 14 of the bottom module 10B.

According to a third interaction, an unmodified cleat pocket 14 of the bottom module 10B interacts with an unmodified cleat 12 of the top module 10A. This is the normal cleat-and-pocket interface described above in relation to FIGS. 1A-1O.

According to a fourth and final interaction, an unmodified cleat pocket 14 of the bottom module 10B interacts with a rail 62 extending through a cleat 12 of the top module 10A. As can be seen in FIG. 2I, the cleat 12 is unable to seat in the cleat pocket 14 because the rail 62 prevents the cleat 12 from being translated in the −Y direction within the cleat pocket 14. As such, the combination of an unmodified array of cleat pockets 14 on a bottom module 10B and a modified cleat 12 having a rail 62 on a top module 10A provides an incompatible cleat-and-pocket interface, locking out engagement between the top module 10A and the bottom module 10B.

The interaction of channels 60, rails 62, unmodified cleats 12, and unmodified cleat pockets 14 described above result in modules 10A, 10B connecting together or being locked out from each other. According to the following discussion, the interaction between modules 10A, 10B is “compatible” if the features allow the modules 10A, 10B to connect together, and the interaction is “incompatible” if the features do not allow, or locks out, the modules 10A, 10B from connecting together. The four possible interactions discussed above are summarized below in Table 1.

TABLE 1
Interactions between modules

Top Module

| | | 0 (unmodified | 1 (cleat 12 |
|---|---|---|---|
| | | cleat 12) | with rail 62) |
| Bottom | 0 (unmodified | Compatible | Compatible |
| | cleat pocket 14) | | |
| Module | 1 (cleat pocket | Incompatible | Compatible |
| | 14 with channel 60) | | |

The foregoing discussion focused on the interaction between one channel 60 and one rail 62 per module 10A, 10B, but there can be multiple rails 62 and/or channels 60 per module 10A, 10B. For the purpose of this disclosure and for the following descriptions, the half-width cleat-and-pocket interface form factor will be the “base unit” for code numbering descriptions. According to certain commercial embodiments, the half-width form factor is the smallest cleat array for PACKOUT™ products, and thus, the description of the interfaces will be based on this form factor when describing various interfaces codes below. As shown in FIGS. 2A and 2B, the half-width array has two columns of cleats 12 and cleat pockets 14, and the number of digits in the interface code will be double the number of features per pocket. That is, a code describing one feature per pocket will have two digits, a code describing two features per pocket will have four digits, and so on. For this disclosure, full-width products will have the same code repeated, essentially being considered as a double half-width.

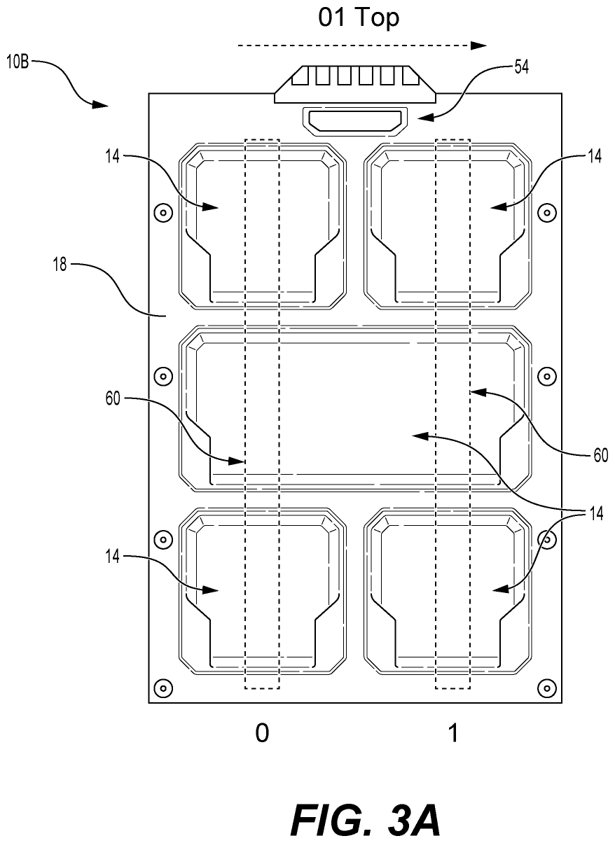

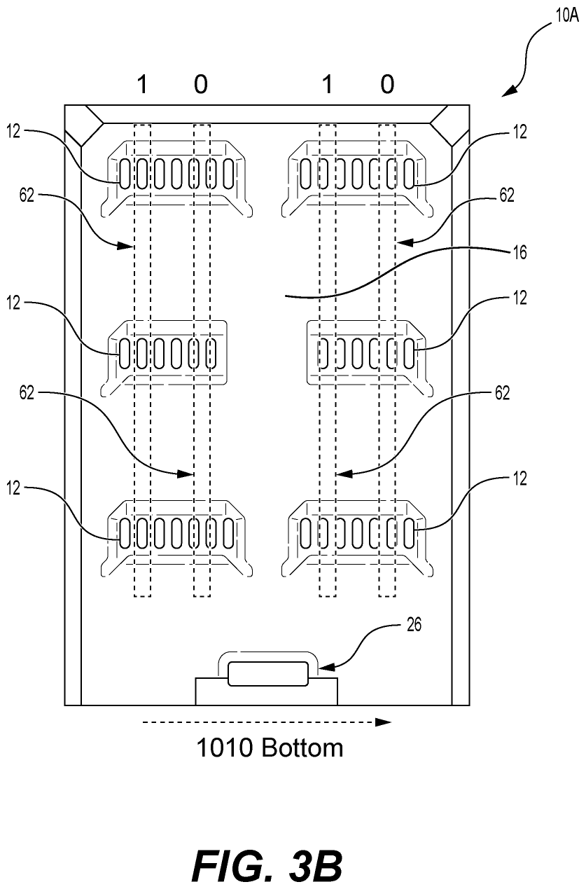

In one or more embodiments, directionality is considered when interpreting the codes. When reading a code corresponding to a top surface 18 of a bottom module 10B, the code will correspond to the top surface 18 of the module 10B oriented such that the recess 54 is at the top as shown in FIG. 3A. Then, the code is read from left to right. With respect to the code “01” as shown in the exemplary embodiment of FIG. 3A, this would mean that the left column of cleat pockets 14 is a “0,” i.e., does not have a channel 60 extending through the left column of cleat pockets 14, and the right column of cleat pockets 14 is a “1,” i.e., does have a channel 60 extending through the right column of cleat pockets 14.

When reading code corresponding to a bottom surface 16 of a top module 10A, the bottom surface 18 is oriented such that the locking tab 26 is at the bottom as shown in FIG. 3B. Then, the code is read from left to right. With respect to the code “1010” as shown in the exemplary embodiment of FIG. 3B, each column of cleats 12 includes two potential positions for rails 62. Thus, in the left column of cleats 12, the “1” corresponds to having a rail 62, and the “0” corresponds to not having a rail 62. In the right column of cleats 12, the “1” again corresponds to having a rail 62, and the “0” corresponds to not having a rail 62. In this way, each individual channel 60, rail 62, and cleat-and-pocket interaction must be “compatible” for the two modules 10A, 10B to connect together. Even just one “incompatible” interaction means that the modules 10A, 10B will not be able to connect together, i.e., they are mechanically locked out from each other. As discussed above, the module connection is “compatible” when the modules 10A, 10B are allowed to connect together, and the module connection is “incompatible” if the modules 10A, 10B are restricted from connecting with each other.

At a threshold level, mating interfaces between the top and bottom modules 10A, 10B should have the same number of digits in the interface codes, and then the codes can be compared to see if any corresponding digits between the codes will prevent combination. As discussed above, all of the digits in each code must be compatible for the interface to be compatible. A single incompatibility between the digits of the respective codes will mechanically lock out the top module 10A from being seated in the bottom module 10B.

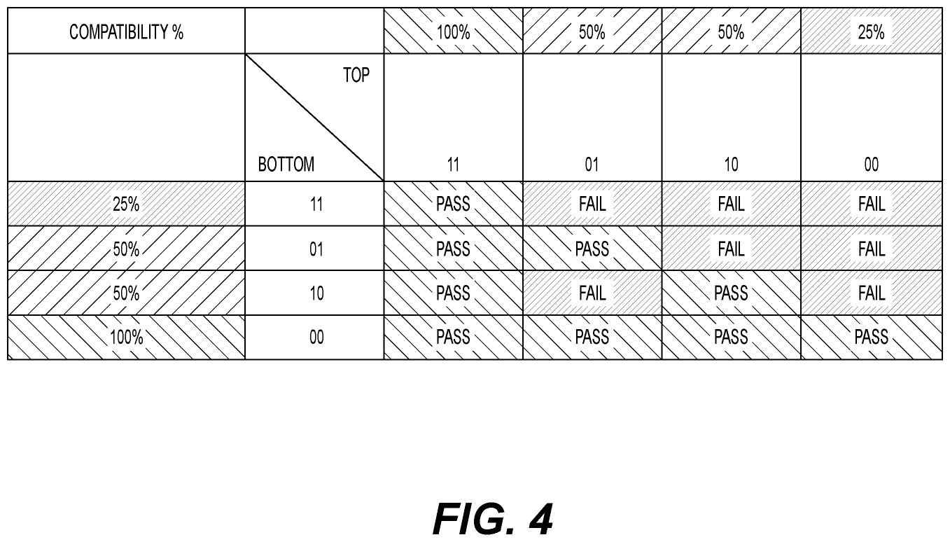

In one or more embodiments, the minimum number of features per cleat 12 or cleat pocket 14 is one with a total of two features per half-width interface. This results in four possible interfaces for the top surface 18 of the bottom module 10B and four possible interfaces for the bottom surface 16 of the top module 10A for a total of 16 unique mating interfaces. FIG. 4 provides a table summarizing the compatibility of the 16 mating interfaces. The table of FIG. 4 also provides a value of “compatibility percentage” associated with interface. Compatibility percentage is a value calculated for each interface and refers to the percentage of interfaces that can be connected to the specified interface. A higher compatibility percentage means more interfaces can be connected to the specified interface, while a lower compatibility percentage means less interfaces can be connected to the specified interface.

As can be seen from FIG. 4, the top surface 18 of the bottom module 10B and the bottom surface 16 of the top module 10A both include the potential codes of “11,” “01,” “10,” and “00.” The “11” interface of the top surface 18 of the bottom module 10B and the “00” interface of the bottom surface 16 of the top module 10A both have a 100% compatibility percentage in that these interfaces can mate with any of the other interface types. By contrast, the “00” interface of the top surface 18 of the bottom module 10B is only compatible with the “00” interface of the bottom surface 16 of the top module 10A, and the “11” interface of the bottom surface 16 of the top module 10A is only compatible with the “11” interface of the top surface 18 of the bottom module 10B. Thus, these two interfaces have a 25% compatibility percentage. The remaining two interfaces “01” and “10” of each of the top surface 18 of the bottom module 10B and the bottom surface 16 of the top module 10A each have a 50% compatibility percentage, engaging with the “11” interface and the corresponding “01” or “10” interface of the opposing module 10A, 10B.

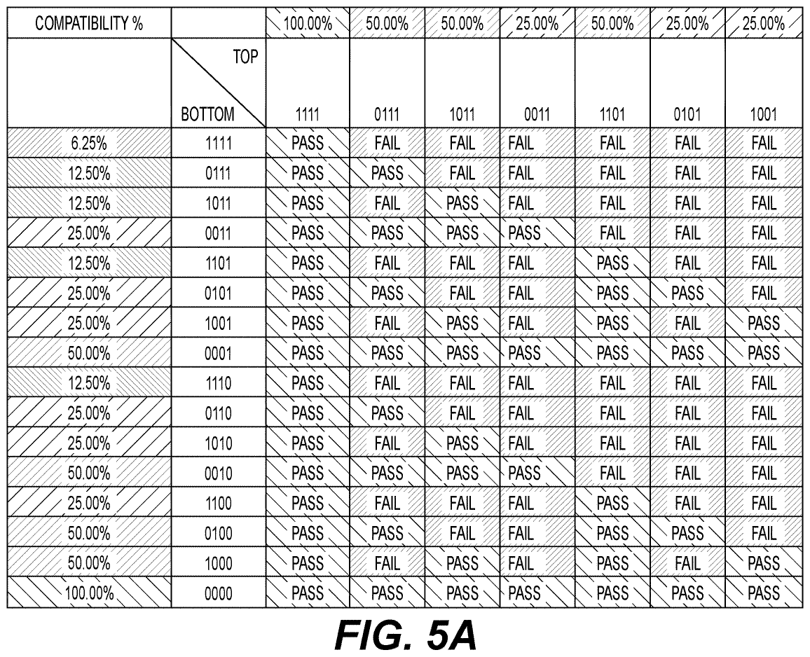

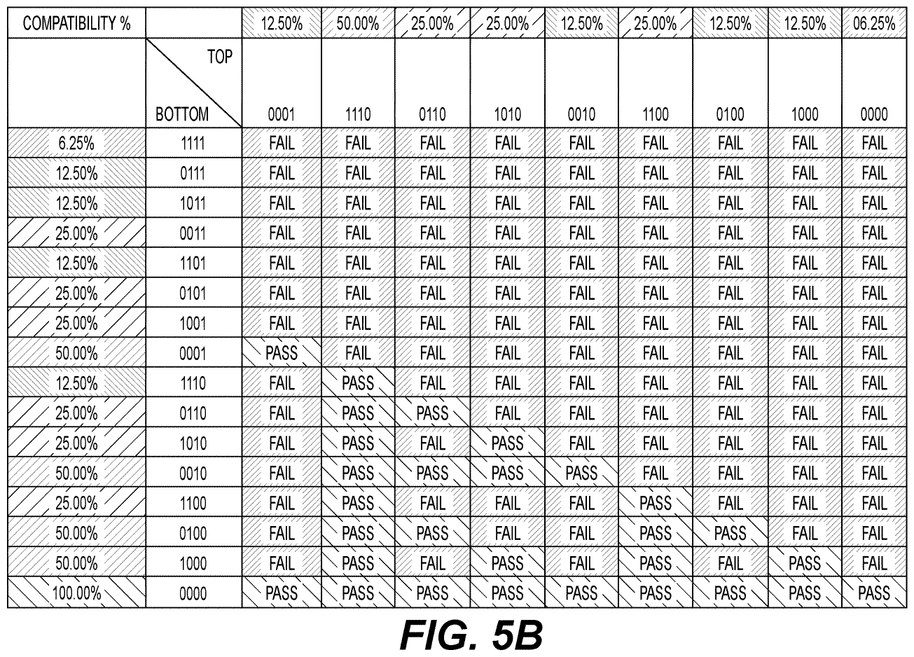

The number of channels 60 and rails 62 per respective column of cleat pocket 14 and cleat 12 can be increased to give a greater selection of lockout combinations. If the number of features per cleat picket 14 or cleat 12 is increased to two, then a total of four channels 60 or rails 62 is provide per half-width interface, resulting in 16 possible interfaces for the top surface 18 of the bottom module 10B, 16 possible interfaces for the bottom surface 16 of the top module 10A, and a total of 256 possible unique mating interfaces. FIGS. 5A and 5B provide a table summarizing the compatibility of the 256 unique mating interfaces as well as the compatibility percentage of each respecting interface of the bottom module 10B and top module 10A.

Depending on the needs and complexity of the system, and the number of components that need to be controlled when being stacked together, a designer can determine the number of unique top/bottom interface interactions required. This can also be quantified using equation 1 below, where the number of unique top/bottom interface interactions is a function of number of features per pocket on a half-width module.

Q=((2ⁿ)²)² (1)
in which Q is the quantity of unique mating interfaces and n is the number of channels 60 or rails 62 per column of cleat pockets 14 or cleats 12. The number of unique mating interfaces (Q) can quickly scale as the number of features (n) per cleat pocket 14 or cleat 12 increases. As shown in Table 2, below, five features per cleat pocket 14 or cleat 12 provides over one million unique mating interfaces for a top module 10A and a bottom module 10B.

TABLE 2
Number of Unique Mating Interfaces based on Feature Inclusion

| Number of Features (n) per | Unique Mating |
|---|---|
| Cleat Pocket or Cleat | Interfaces |
| 1 | 16 |
| 2 | 256 |
| 3 | 4096 |
| 4 | 65,536 |
| 5 | 1,048,576 |

The compatibility percentage of an interface can be calculated using Equations 2 and 3, below, for the top surface 18 of the bottom module 10A and the bottom surface 16 of the top module 10B, respectively.

C_{T}=2^{x}/n² (2)

C_{B}=2^{(n-x)}/n² (3)

In which C_{T} is the compatibility percentage for the top surface 18 of the bottom module 10B, C_{B} is the compatibility percentage of the bottom surface 16 of the top module 10A, x is the number of features (channels 60 or rails 62) present in the interface (i.e., the number of “1”s in the interface code), and n is the number of total features (channels 60 or rails 62) in the interface (i.e., the number of total digits in the interface code). Knowing the compatibility percentage can be helpful when designing a module 10A, 10B to have a certain level of compatibility. For example, a module can be designed to be more accepting of other modules by selecting a design with a higher compatibility percentage based on Equations 2 and 3. Conversely, a module can be designed to be mechanically locked-out from most other modules by selecting a design with a lower compatibility percentage.

As will be understood from the foregoing discussion, there are benefits in designing modules 10A, 10B to limit stacking in certain configurations. That is, by using the mechanical lock out interfaces according to the present disclosure, the placement of a module on or within a stack can be controlled without overly limiting potential future iterations of the module ecosystem.

While there are benefits to allowing full compatibility between various modules provided within the cleat-and-pocket interface system, there may also be reasons to limit or completely disallowing certain stacking configurations or compatibility between certain modules. For example, it may be desirable to limit compatibility between older generations of modules and newer generations of modules where combination of such modules could create a hazard or affect the operability of the system. As another example, heavier modules within the ecosystem may be designed with interface compatibility that limits them to lower positions within a stack so that the stack is not accidentally made top heavy, which could cause the stack to tip. Still further, certain ecosystem components can be designed with an interface that is compatible for stacking onto existing mobility or mounting structures, such as a rolling tool box, mounting plate, or dolly. Additionally, the modules can be designed to stack in such a way that avoids unlikely or impractical configurations, instead focusing on stack configurations that optimize performance of the modules within the stack. In this way, users are deterred from building restricted stacks, improving user experience and reducing confusion caused by inoperable stacks.

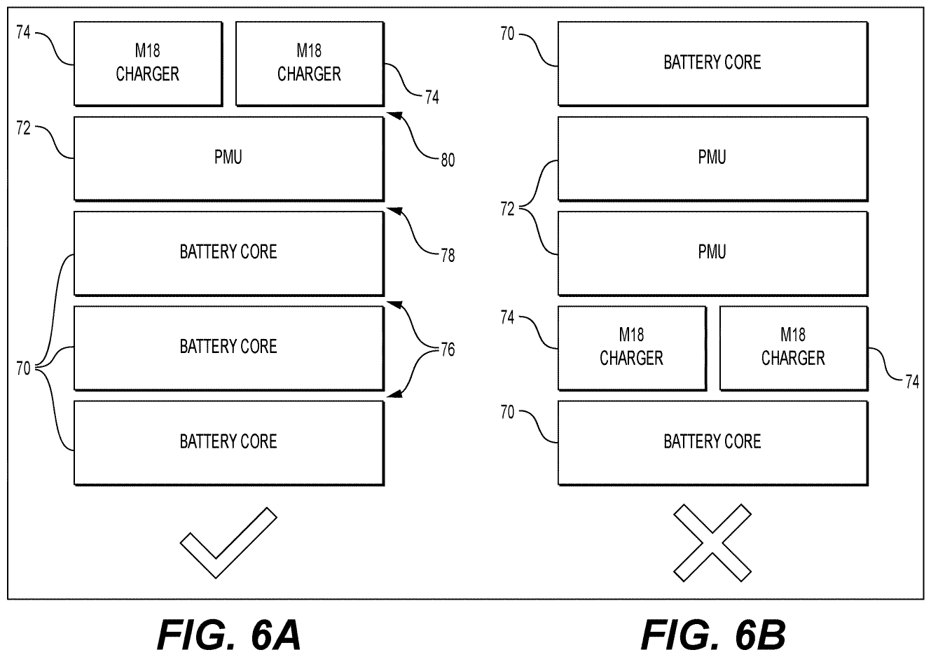

FIGS. 6A and 6B illustrate two stacks of modules illustrating potential limitations on stacking configurations based on the use of mechanical lockouts. As can be seen, each stack includes battery cores 70, a power maintenance unit (PMU) 72, and power tool battery chargers 74. The battery cores 70 and PMU 72 are have full width interfaces, and the battery chargers 74 have half width interfaces. According to the exemplary system, the battery cores 70 are desired to be grouped together and located at the bottom of the stack. The PMU 72 is to be placed on top of the battery cores 70, and the battery chargers 74 are to be placed on top of the battery cores 70 and the PMU 72. Within the system, other cleat-and-pocket modules can be placed on top of the battery cores 70 and PMU 72 but not the battery chargers 74. Further, other cleat-and-pocket modules can be positioned below the battery chargers 74 but not below the battery cores 70 or the PMU 72. As shown in FIG. 6A, a first mating interface 76 between the battery cores allows for stacking of one battery core 70 onto another battery core 70. A second mating interface 78 between the topmost battery core 70 and the PMU 72 allows for stacking of the PMU 72 on the battery core 70, and a third mating interface 80 between the PMU 72 and the battery chargers 74 allows for stacking of the battery chargers 74 onto the PMU 72.

In one or more embodiments, the battery cores 70 can have an interface code of 1111 on the top surface and an interface code of 1111 on the bottom surface. As shown in FIGS. 5A and 5B, the interface code of 1111 on the bottom surface is only compatible with the interface code of 1111 on the top surface, mechanically locking the battery core 70 out from being stacked on another module. Thus, the first mating interface 76 is between top and bottom surfaces having interface code 1111.

In one or more embodiments, the PMU 72 can have an interface code of 0000 for the bottom surface and an interface code of 0101 for the top surface. As shown in FIGS. 5A and 5B, the interface code of 0000 on the bottom surface of the PMU 72 is compatible with the interface code of 1111 on the top surface of the battery core 70, making the second mating interface 78 correspond to a top surface interface of 1111 and a bottom surface interface of 0000 (i.e., a standard cleat-and-pocket design).

In one or more embodiments, the battery chargers 74 include an interface code of 00 on the bottom surface. As mentioned, the battery chargers 74 in the present example embodiment are half-width structures, and thus, placing two battery chargers 74 side-by-side would essentially amount to an interface code of 0000 (each half being a standard cleat-and-pocket design). The interface 0101 on the top surface of the PMU 72 is compatible with the 0000 interface defined by the bottom surfaces of the battery chargers 74, thereby making the third mating interface 80 correspond to a top surface interface of 0101 and a bottom surface interface of 0000. In order to prevent stacking on top of the battery chargers 74, no cleat pockets are provided on top of the battery chargers.

As shown in FIG. 6B, the top and bottom surface interfaces described prevent certain stacking configurations. While the 1111 interface on the top surface of the battery core 70 allows for stacking of the battery chargers 74 having a bottom surface with a 0000 interface, the lack of cleat pockets on the top of the battery chargers 74 prevents stacking of any other module over the battery chargers. Further, while the stacking of one PMU 72 on another PMU 72 is permitted based on the mating interfaces of a top surface of 0101 and a bottom surface of 0000, the battery core 70 is not permitted to be stacked on top of the PMU 72 because the bottom surface interface of 1111 on the battery core 70 is not compatible with the top surface interface of 0101 of the PMU 72.

In addition to or instead of the modifications to the cleat-and-pocket interface described in the foregoing, the modules 10A, 10B can be configured to provide another feature, such as different insertion distances when joining together the two modules 10A, 10B. For electrical modules 10A, 10B, the electrical interfaces, in general, are also connected with a translation in one axis until all the contacts are connected to their corresponding contacts in the mating interface. Examples of suitable mechanisms for forming electrical connection between the modules 10A, 10B can be found in International Patent Application No. PCT/US2025/030369, filed on May 21, 2025, the entire contents of which are incorporated herein by reference thereto. Users tend to prefer forming the mechanically and electrically connection in the same motion. The insertion distance for certain commercially available modules having a cleat-and-pocket interface is 26 mm, which is limited by the geometry of the cleat and cleat pocket. This is the distance the top module translates in the Z direction to click into place. If the electrical interface is located at one end of the module, the electrical connection could be made while the mechanical connection is being made. The difficulty in forming the electrical connection is being limited by the 26 mm of insertion distance. In particular, the insertion distance required for the electrical interface depends on a multitude of factors, including contact insertion timing, ingress and pollution degree requirements, and terminal float, amongst others. As will be discussed more fully below, the interface between modules 10A, 10B defined by the cleat 12 and cleat pockets 14 is enlarged from the conventional 26 mm insertion distance, providing more distance to fully mate and meet the multitude of other requirements for operation.

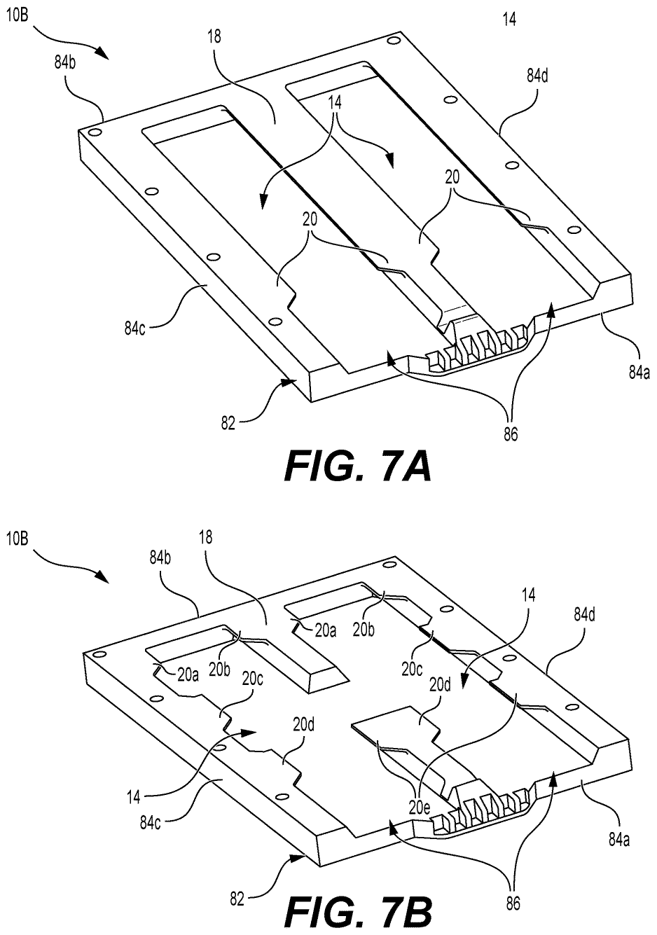

FIG. 7A depicts an embodiment of a first geometry of a cleat pocket 14 in which the cleat pocket 14 is a long, continuous pocket in the Z-direction as compared to a column of, e.g., three, shorter cleat pockets as shown and described in various embodiments above. In one or more embodiments, the bottom module 10B includes a cover 82 defining the top surface 18. The cover 82 includes a plurality of sides 84a-d in which the first side 84a is opposite to the second side 84b and the third side 84c is opposite to the fourth side 84d. As can be seen, the cleat pocket 14 extends from an opening 86 in the first side 84a toward the second side 84b. The first side 84a is separated from the second side 84b by a distance D. In one or more embodiments, the cleat pocket 14 extends at least 50%, at least 75%, or at least 90% of the distance D from the first side 84a to the second side 84b. Further, in one or more embodiments, the tabs 20 of the cleat pocket 14 extend along at least 50%, at least 60%, or at least 75% of the length of the cleat pocket 14. In one or more particular embodiments, the cleat pocket 14 has a length in a range of 200 mm to 250 mm, in particular bout 226 mm. As compared to the conventional cleat pocket length of 26 mm, the long cleat pocket 14 provides a much greater insertion distance for making an electrical connection when combining modulus 10A, 10B.

FIG. 7B depicts an embodiment of a second geometry of a cleat pocket 14 in which the cleat pocket 14 is a long, continuous pocket in the Z-direction, but instead of also having a long continuous cleat tab 20, the cleat tab 20 extends over the negative space of the cleat pocket 14 in a variable manner. That is, each cleat pocket 14 includes a plurality of tabs 20a-20e, essentially mimicking the three individual cleat pockets of the conventional embodiment. As can be seen, the middle cleat pocket 14 is a double cleat pocket extending across the top surface 18 from the third side 84c to the fourth side 84d.

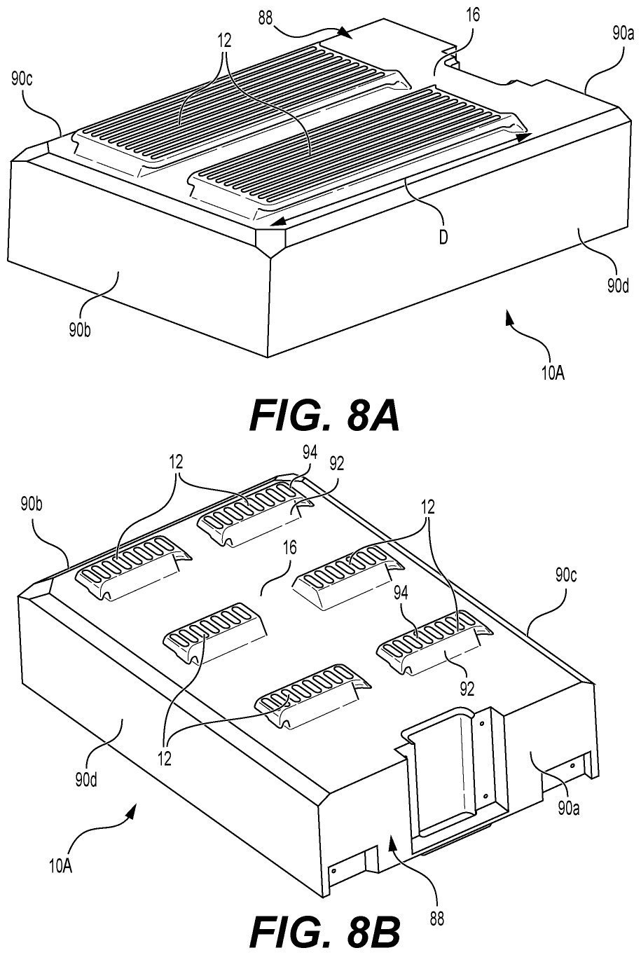

FIG. 8A depicts an embodiment of a first geometry of a cleat 12 in which the cleat 12 is a long, continuous cleat 12 in the Z-direction as compared to multiple discrete cleats arranged in columns as described in various embodiments above. In one or more embodiments, the bottom module 10B includes a container 88 defining the bottom surface 16. The container 88 includes a plurality of sides 90a-d in which the first side 90a is opposite to the second side 90b and the third side 90c is opposite to the fourth side 90d. As can be seen, the cleat 12 extends from proximate the second side 90b toward the first side 90a. The first side 90a is separated from the second side 90b by the distance D. In one or more embodiments, the cleat 12 extends at least 50%, at least 60%, or at least 75% of the distance D from proximate the second side 90b toward the first side 90a. When combined with the long, continuous cleat pocket 14, the long cleat 12 provides a much greater insertion distance, e.g., up to 226 mm, for making an electrical connection when combining modulus 10A, 10B.

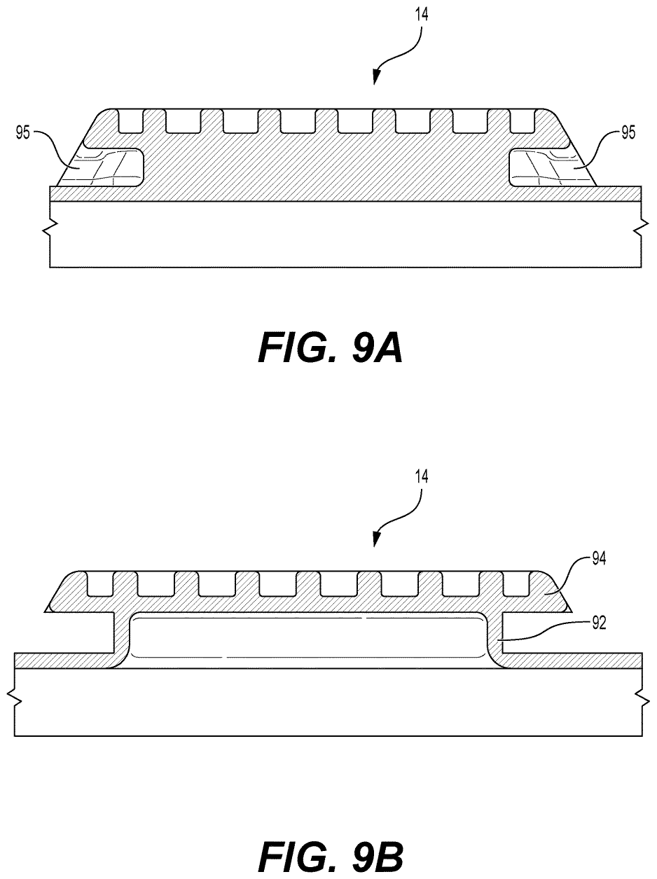

FIG. 8B depicts an embodiment of a second geometry of a cleat 12 in which the cleat 12 has a T-shaped configuration. As shown in FIG. 8B, the cleat 12 includes a central post 92 and a cross member 94 extending across the post 92 such that the cross member 94 extends past both sides of the post 92. FIGS. 9A and 9B provide a comparison of an unmodified cleat as compared to the T-shaped cleat 12. As can be seen, the T-shaped cleat 12 does not include any webbing material 95 disposed beneath the cross member 94 on the sides of the central post 92, which allows the T-shaped cleat 12 to slide within and along the full length of the cleat pocket 14. In one or more embodiments, the T-shaped cleat 12 can be combined with both the long-continuous cleat pocket 14 as shown in FIG. 7A and with the cleat pocket 14 having a plurality of tabs 20 as shown in FIG. 7B.

The two disclosed cleat pockets 14 as shown in FIGS. 7A and 7B and the conventional cleat pocket create three possibilities for the mating interface on the top surface 18 of the bottom module 10B. Similarly, the two disclose cleats 12 as shown in FIGS. 8A and 8B and the conventional cleat create three possibilities for the mating surface on the bottom surface 16 of the top module 10A. The combined six geometries create nine possible combinations of the top module 10A and the bottom module 10B as summarized in Table 3, below.

TABLE 3
Cleat and Cleat Pocket Combinations

| | | Cleat Pocket Option | | |
|---|---|---|---|---|
| | | Unmodified | Long Pocket | Variable Pocket |
| Cleat | Unmodified | Compatible, | Incompatible | Compatible, |
| Options | | 26 mm | | 26 mm |
| | Long Cleat | Incompatible | Compatible, | Compatible |
| | | | 226 mm | 226m m |
| | T-shaped | Compatible, | Compatible, | Compatible, |
| | Cleat | 26 mm | 226 mm | 26 mm OR 123 mm |
| | | | | OR 226 mm |

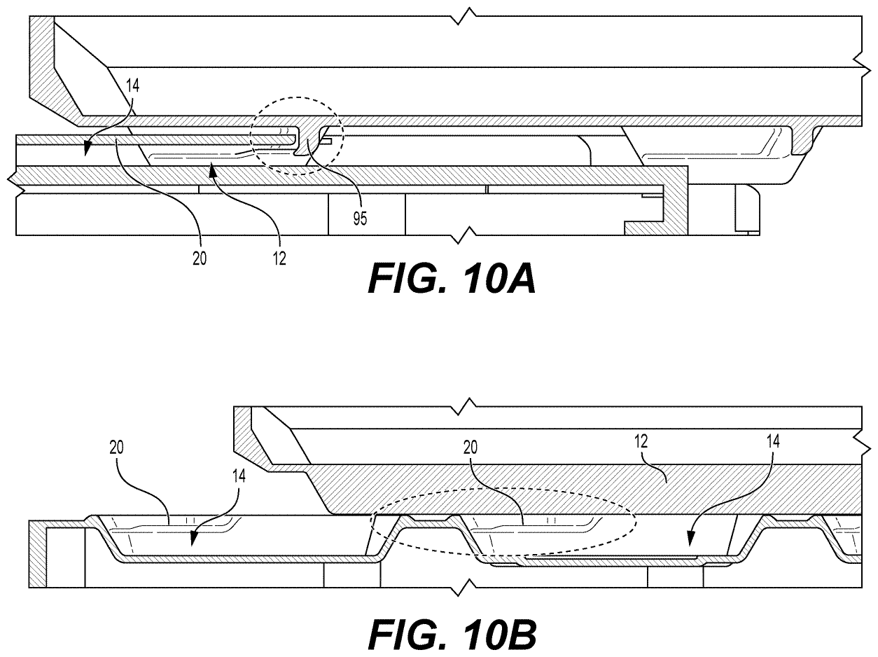

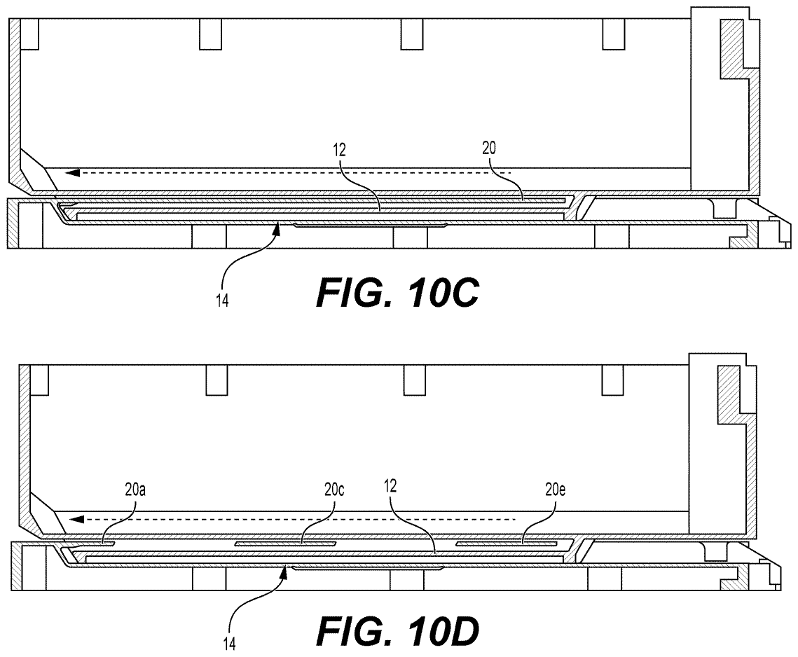

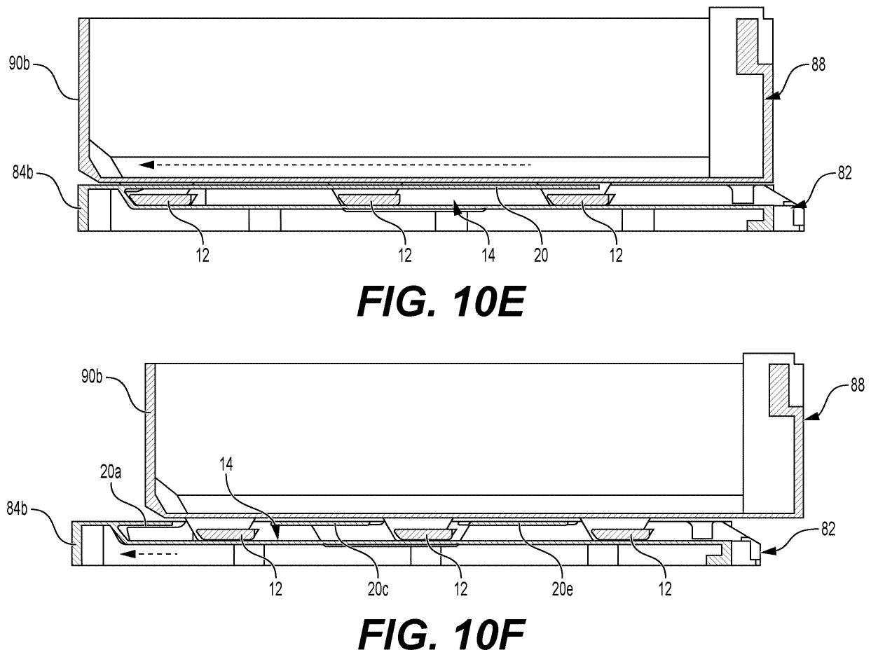

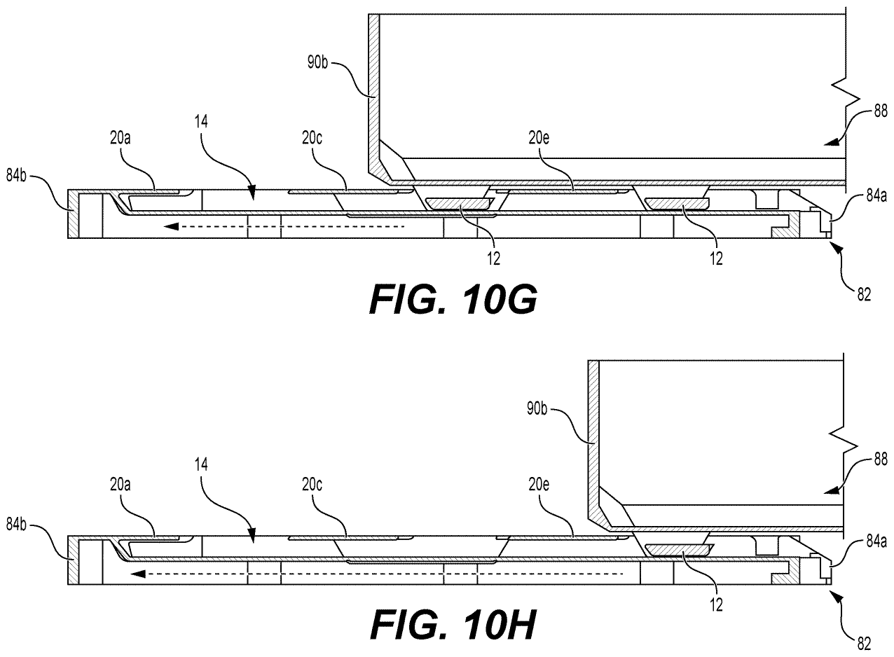

The first interaction is the unmodified cleat and unmodified pocket, which are compatible with each other and have an insertion distance of 26 mm. The second interaction is unmodified cleat with the long pocket. The two interfaces are incompatible as shown in FIG. 10A. As can be seen, the tab 20 of the long cleat pocket 14 contacts the webbing 95 of the cleat 12, preventing the cleat 12 from being inserted further into the cleat pocket 14. The third interaction is unmodified cleat 12 with the variable cleat pocket 12 having a plurality of tabs 20a-e. The two interfaces are compatible and connect in the same way as the unmodified cleat pocket, resulting in an insertion distance of 26 mm.

The fourth interaction is the long cleat 12 with the unmodified cleat pocket, which are incompatible as shown in FIG. 10B. In particular, the long cleat 12 is too large and does not fit into the cleat pockets, preventing insertion of the cleats 12 into the cleat pockets 14. The fifth interaction is the long cleat 12 with the long cleat pocket 14, which is a compatible interface with an insertion distance of 226 mm. The insertion of the long cleat 12 into the long cleat pocket 14 is shown in FIG. 10C. The sixth interaction is a long cleat 12 with the variable cleat pocket 14 having a plurality of tabs 20a-e. This is also a compatible interface providing an insertion distance of 226 mm as shown in FIG. 10D.

The seventh interaction is the T-shaped cleat 12 with the unmodified cleat pocket 14, which is a compatible interface providing an insertion distance of 26 mm. This interaction essentially operates the same way as the unmodified cleat 12 and the unmodified cleat pocket 14. The eighth interaction is the T-shaped cleat 12 with the long cleat pocket 14. The two interfaces are compatible and provide an insertion distance of 226 mm as shown in FIG. 10E. The ninth interaction is the T-shaped cleats 12 with the variable pocket 14 having a plurality of tabs 20a-e. The two interfaces are compatible and provide an insertion distance of 26 mm, 123 mm, or 226 mm, depending on where the T-shaped cleats are inserted into the variable cleat pocket 14. FIGS. 10F-10H depict various insertion points providing the different insertion distances for this interaction. As shown in FIG. 10F, the T-shaped cleat 12 closest to the second side 90b of the container 88 is inserted into the portion of the cleat pocket 14 closest to the second side 84b of the cover 82, providing the shortest insertion distance (e.g., 26 mm). As shown in FIG. 10G, the T-shaped cleat 12 closest to the second side 90b of the container 88 is inserted into the portion of the cleat pocket 14 intermediate of the first side 84a and the second side 84b of the cover 82, providing an intermediate insertion distance (e.g., 123 mm). As shown in FIG. 10H, the T-shaped cleat 12 closest to the second side 90b of the container 88 is inserted into the portion of the cleat pocket 14 closest to the first side 84a of the cover 82, providing the longest insertion distance (e.g., 226 mm).

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A module of a portable power ecosystem configured to be incorporated into a stacked configuration, the module comprising:
a top surface,
a bottom surface, and
a plurality of sidewalls connecting the top surface and the bottom surface;
wherein the top surface extends from a first end of the module to a second end of the module;
wherein the top surface defines a first column comprising at least one first cleat pocket and a second column comprising at least one second cleat pocket;
wherein the bottom surface extends from the first end to the second end;
wherein the bottom surface defines a third column comprising at least one first cleat and a fourth column comprising at least one second cleat;
wherein at least one of the first column or the second column comprises a first feature configured to permit or prevent the at least one first cleat of the third column or the at least one second cleat of the fourth column of an upwardly adjacent module in the stacked configuration from seating in the at least one first cleat pocket or the at least one second cleat pocket, respectively; and
wherein at least one of the third column or the fourth column comprises a second feature configured to permit or prevent the at least one first cleat of the third column or the at least one second cleat of the fourth column of the module from seating in the at least one first cleat pocket or the at least one second cleat pocket, respectively, of a downwardly adjacent module in the stacked configuration.

2. The module of claim 1, wherein the first feature is a channel extending through the at least one first cleat pocket of the first column or the at least one second cleat pocket of the second column.

3. The module of claim 2, wherein the channel extends only through the at least one first cleat pocket and not the at least one second cleat pocket.

4. The module of claim 2, wherein the second feature is a rail extending through the at least one first cleat of the third column or the at least one second cleat of the fourth column.

5. The module of claim 4, wherein the rail extends only through the at least one first cleat and not through the at least one second cleat.

6. The module of claim 1, wherein the at least one first cleat pocket is a single cleat pocket that extends at least 50% of a distance between the first end and the second end.

7. The module of claim 6, wherein the single cleat pocket comprises tabs that extend along sides of the single cleat pocket for at least 50% of a length of the single cleat pocket.

8. The module of claim 6, wherein the single cleat pocket comprises a plurality of tabs along each side of the single cleat pocket.

9. The module of claim 6, wherein the at least one first cleat is a single cleat that extends 50% of the distance between the first end and the second end.

10. The module of claim 6, wherein the at least one first cleat comprises at least two first cleats and wherein a cross-sectional profile of each of the at least two first cleats taken perpendicular to the bottom surface comprises a central post and a cross member that extends across the central post such that the cross member extends past opposing sides of the post.

11. A portable power ecosystem, comprising:
a plurality of modules configured to be arranged in an interlocking stacked configuration;
wherein each module of the plurality of modules comprises (i) a top mating interface including at least one cleat pocket, the top mating interface being configured to interact with an upper adjacent module, and (ii) a bottom mating interface comprising at least one cleat, the bottom mating interface being configured to interact with a bottom adjacent module;
wherein the plurality of modules comprises a first module in which the top mating interface or the bottom mating interface is incompatible with the bottom mating interface or the top mating interface, respectively, of a second module of the plurality of modules to prevent interlocked stacking of the second module above or below the first module.

12. The portable power ecosystem of claim 11, wherein, when the plurality of modules are in the interlocking stacked configuration, the plurality of modules are mechanically and electrically connected.

13. The portable power ecosystem of claim 12, wherein the first module and the second module are prevented from being electrically connected when the second module is arranged with the bottom mating interface over the top mating interface of the first module.

14. The portable power ecosystem of claim 11, wherein the top mating interface of a third module of the plurality of modules comprises at least one channel extending through the at least one cleat pocket.

15. The portable power ecosystem of claim 14, wherein the bottom mating interface of a fourth module of the plurality of modules comprises at least one rail extending through the at least one cleat, the at least one rail configured to be seated within the at least one channel when the fourth module is stacked on the third module in the interlocking stacked configuration.

16. The portable power ecosystem of claim 11, wherein the at least one cleat pocket of the top mating interface of a third module of the plurality of modules comprises a single cleat pocket that extends at least 50% of a distance between a first end and a second end of the third module.

17. The portable power ecosystem of claim 16, wherein the single cleat pocket comprises tabs that extend along sides of the single cleat pocket for at least 50% of a length of the single cleat pocket.

18. The portable power ecosystem of claim 16, wherein the single cleat pocket comprises a plurality of tabs along each side of the single cleat pocket.

19. The portable power ecosystem of claim 16, wherein the at least one cleat of the bottom mating interface of a fourth module of the plurality of modules comprises a single cleat that extends at least 50% of the distance between a first end and a second end of the fourth module.

20. The portable power ecosystem of claim 16, wherein the at least one cleat of the bottom mating surface of a fourth module of the plurality of modules comprises at least two cleats and wherein a cross-sectional profile of each of the at least two cleats taken perpendicular to a bottom surface of the fourth module comprises a central post and a cross member that extends across the central post such that the cross member extends past opposing sides of the post.
